(19) United States
(12) Patent Application Publication
(10) Pub. No.: US 2008/0208378 A1
(43) Pub. Date: Aug. 28, 2008

(54) MEDIA PLAY SYSTEM

(75) Inventors: John Booth, Chiswick (GB); Amanda Davidson, Twickenham (GB); Mark Gray, Acton (GB); Matthew Simmons, Basingstoke (GB)

Correspondence Address: KNOBBE MARTENS OLSON & BEAR LLP, 2040 MAIN STREET, FOURTEENTH FLOOR, IRVINE, CA, 92614, US

(73) Assignee: DigiFi Limited, London (GB)

(21) Appl. No.: 12/036,186

(22) Filed: Feb. 22, 2008

Related U.S. Application Data
(63) Continuation of application No. PCT/GB2006/003120, filed on Aug. 21, 2006.

(30) Foreign Application Priority Data
Aug. 23, 2005 (GB) 0517260.6

(51) Int. Cl. G06F 17/00

(52) U.S. Cl. 700/94

(57) ABSTRACT

A method and system for playing media are disclosed. The media play system comprises a media server comprising a plurality of outputs, wherein each of the plurality of outputs is connected to a playback station, wherein the media server is connected to at least one device that is configured to store digital content, and wherein the at least one device comprises either a mobile media player docked in a mobile media docking mechanism or a local network connected to a media track storage. The method comprises media retrieving a plurality of media tracks stored in a plurality of devices, wherein each of the plurality of devices comprises either a mobile media player docked in a mobile media docking mechanism or a local network connected to a media track storage and wherein the media tracks stored therein are seen as a single collection of tracks and substantially simultaneously outputting the plurality of media tracks to a plurality of playback stations.

### CROSS-REFERENCE TO RELATED APPLICATIONS

This application is a continuation of International Application Number PCT/GB2006/003120, filed Aug. 21, 2006, which is hereby incorporated by reference. PCT/GB2006/003120 also claims priority from GB 0517260.6 filed Aug. 23, 2005, which is hereby incorporated by reference.

### BACKGROUND OF THE INVENTION

1. Field of the Invention

This invention relates to a system for playing media such as audio, video and the like, or for showing photographs.

2. Description of the Related Technology

It is known to provide a media file server and a computer hub device, and to control both items of hardware by wireless control means. This is illustrated in FIG. 1 in which a media file server 101 with an output device 103 for playing audio or video recordings has a wireless communication device 109 such as Bluetooth or the WLAN (Wireless Local Area Network) standard known as WiFi.

The server 101 is located in the vicinity of a computer hub device 105 with wireless communication means (not shown separately), and also in the vicinity is a handheld remote control unit 107, also with a wireless communication device 109. By utilizing the computer hub 105 to pass an instruction from the remote control unit to the server 101, playback on the output device 103 can be instructed.

It is also known to provide a peer-to-peer wireless controlled network as disclosed in the applicant's co-pending patent application GB 0230278.4 and illustrated schematically in FIG. 2. A media server 203 (in effect a modified PC having a loudspeaker output) into which Compact Discs (CDs) can be loaded, a mobile handheld computing device 205 (such as a Personal Digital Assistant) and a satellite device 207 all communicate with each other by wireless links 201. The satellite device 207 incorporates media player and playlist manipulator software and is connected to a speaker. While the media to be played may be video or photographic records, a frequent use is to play music.

Such a system permits a user's entire CD collection to be ripped and encoded for efficient storage in the media server and to be played by remote wireless instruction.

### SUMMARY OF CERTAIN INVENTIVE ASPECTS

In one embodiment, there is a media play system comprising a media server comprising a plurality of outputs, wherein each of the plurality of outputs is connected to a playback station, wherein the media server is connected to at least one device that is configured to store digital content, and wherein the at least one device comprises either a mobile media player docked in a mobile media docking mechanism or a local network connected to a media track storage.

In another embodiment, there is a method of outputting media, the method comprising retrieving a plurality of media tracks stored in a plurality of devices, wherein each of the plurality of devices comprises either a mobile media player docked in a mobile media docking mechanism or a local network connected to a media track storage and wherein the media tracks stored therein are seen as a single collection of tracks and substantially simultaneously outputting the plurality of media tracks to a plurality of playback stations.

In another embodiment, there is a media play system comprising means for retrieving a plurality of media tracks stored in a plurality of devices, wherein each of the plurality of devices comprises either a mobile media player docked in a mobile media docking mechanism or a local network connected to a media track storage and wherein the media tracks stored therein are seen as a single collection of tracks and means for substantially simultaneously outputting the plurality of media tracks to a plurality of playback stations.

### BRIEF DESCRIPTION OF THE DRAWINGS

FIG. 1 is a functional block diagram of a typical media player system.

FIG. 2 is a functional block diagram of another typical media player system.

FIG. 3 is a functional block diagram of a media player system according to an embodiment of the invention.

FIG. 4 is a functional block diagram of the control software associated with the embodiment of the media player system shown in FIG. 3.

FIGS. 5a and 5b illustrate typical displays on the monitor of the media player system according to one embodiment of the invention.

FIG. 6 is a functional block diagram of a media player system according to another embodiment of the invention.

FIG. 7 is a functional block diagram of a media player system according to another embodiment of the invention.

FIG. 8 is a functional block diagram of the control software associated with the embodiment of the media player system shown in FIG. 7.

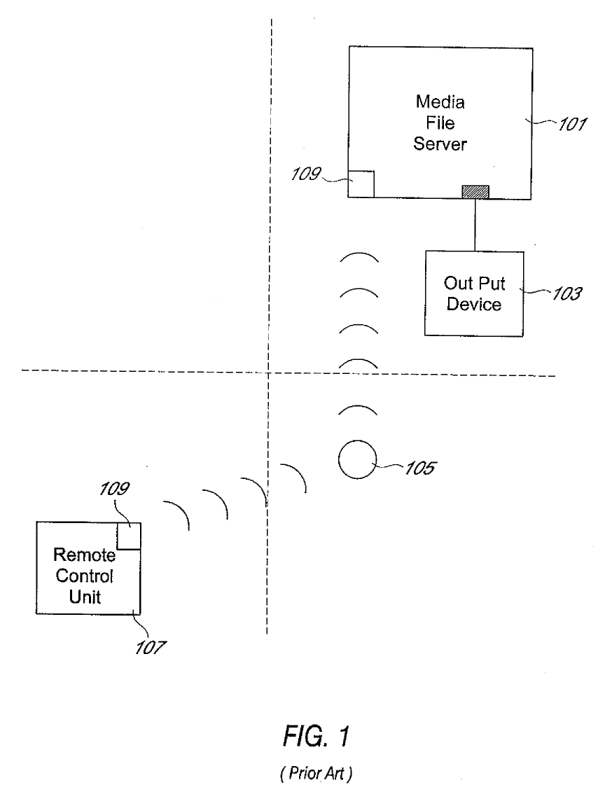

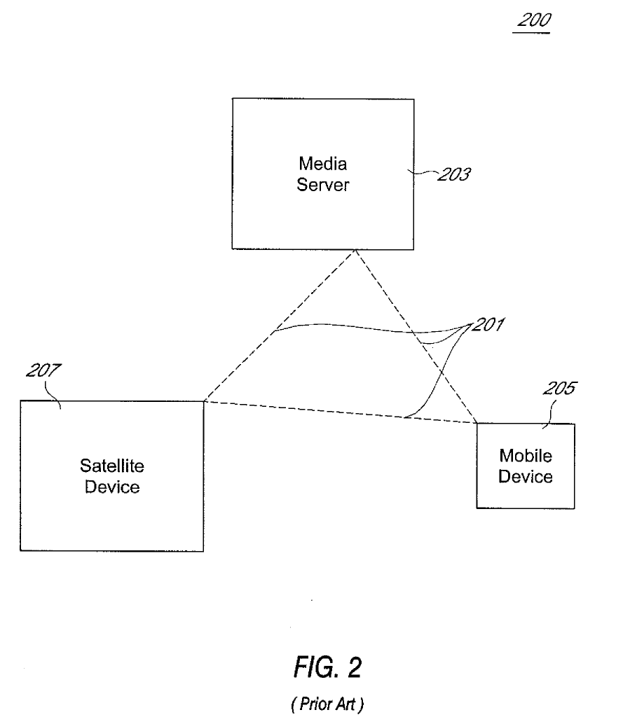

### DETAILED DESCRIPTION OF CERTAIN INVENTIVE EMBODIMENTS

A recent phenomenon is the use of mobile audio players, such as those operating on the MP3 standard and known as MP3 players; these may be hard drive or solid state. Users can carry their entire music collection with them at all times after ripping and encoding CDs by use of a PC or by downloading from the Internet. If a user wishes to play a track on a home audio system, the MP3 player can be connected to it by a flying (analogue) audio cable or by a basic MP3 player docking station which uses a similar flying cable, but remote control of the audio system is limited to the simple controls on the MP3 player itself, such as “start”, “stop”, “forward”, skip”. This may not be convenient.

One embodiment of the invention provides a more convenient remote play device for mobile audio players.

Digital content such as music is also storable on devices connected to a local network, such as a PC, or a laptop or a network attached storage device (NAS). Another embodiment of the invention provides a convenient remote play device for such digital content.

In another embodiment of the invention, a media play system comprises a media server having a plurality of outputs each connectable to a different playback station; the server also being connectable to at least one device that is capable of storing digital content, such device being either a mobile media player docked in a mobile media docking mechanism or a local network having connected to it a device having media tracks stored therein.

The media play system may be arranged so that a plurality of tracks from the device that is capable of storing digital content are connectable simultaneously to a plurality of playback stations.

The system may be arranged so that a plurality of devices capable of storing digital content are connectable simultaneously and the media tracks stored therein are seen as a single collection of tracks.

The media server may be a modified personal computer and the playback stations may be high fidelity music systems in different rooms of a house or office or hotel. Each docking mechanism may be suitable for docking a device such as an MP3 player.

In a typical media play system, music stored in an MP3 player is played through an analogue system. In an embodiment of the invention, music is played using digital data accessed from data files stored in the MP3 player.

When the device capable of storing digital content is a device connected to a local network, the device is generally addressable and discoverable by the media server; such devices include laptops and NASs and PCs including those which have been deliberately hidden from the server and the network for security reasons but where authentication codes are available.

Also in one embodiment of the invention, the media play system further comprises control software loaded onto storage means in the media server, the control software comprising a remote interface layer arranged to communicate with: a) an interface of at least one instruction input system; b) the plurality of outputs; and c) the at least one device capable of storing digital content.

The at least one instruction input system may be an infra-red or touch input, or a WiFi-capable Personal Digital Assistant, or a PC operating via LAN or WiFi, or a mini-Video Graphics Adapter, or an intelligent building control system such as that supplied by Crestron using RS232 or Internet Protocol.

The control software may be arranged to access digitally the media stored in the mobile media players when docked and to provide a digital link to a selected output port. As is conventional, any networked device is accessed digitally.

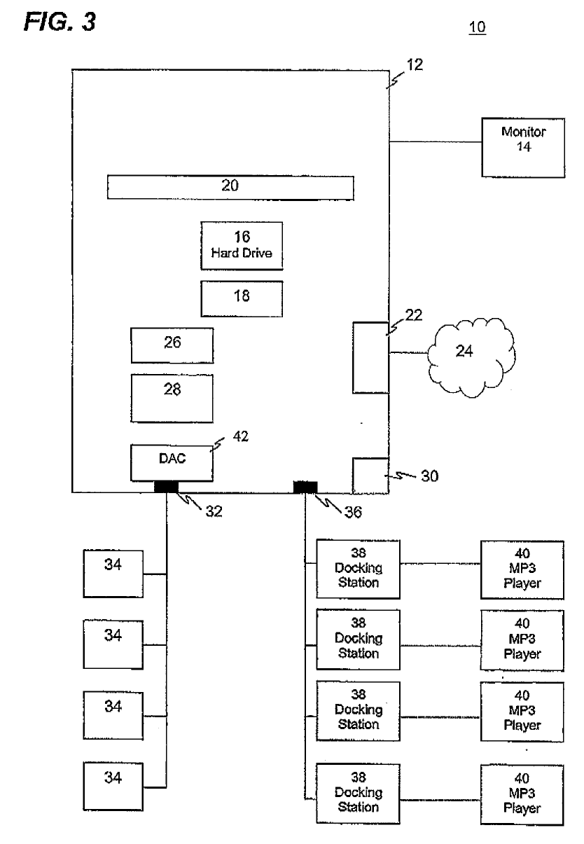

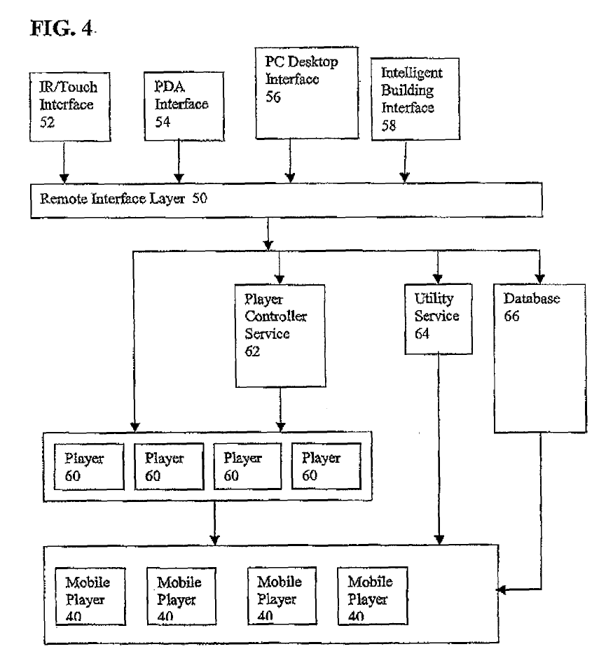

FIG. 3 is a functional block diagram of a media player system according to an embodiment of the invention. In FIG. 3 a media player system 10 comprises a media server 12 which is a modified PC. The PC has a monitor 14 (or it can be connected to a television screen), and includes a small hard disc drive 16 which stores conventional operating software and control software according to one embodiment of the invention, which will be described with reference to FIG. 4. The hard drive may be small because, as will be seen, it does not store music files and cost can therefore be reduced.

The PC 12 also includes a software utility service 18, a database server 20, a modem 22 for connection to the Internet 24, a playlist manipulator 26 and media player software 28. There is also a wireless input/output port 30.

The PCI2 has a first port 32 connected to four Hi-Fi players 34 which are in different rooms of the user's house. The PC 12 has a second port 36 which is connected to four docking stations 38 each arranged to receive a MP3 player 40 as indicated by the dotted lines. Each MP3 player contains a store of digitally recorded music, often encoded and compressed, originally taken from a CD by use of a PC for ripping and encoding, or from the Internet or from any other source, as is conventional.

When two or more MP3 players are docked, the PC 12 is arranged so that any track on any MP3 player can be selected to be played on any Hi-Fi system 34.

In effect, the contents of the two or more docked players are seen as a single music collection. Each Hi-Fi 34 is controllable independently, and a series of recordings from the same or different MP3 players 40 can be directed to any Hi-Fi in any selected order.

In effect, each MP3 player 40, when docked, acts as a hard drive for the system. There is no digital to analogue conversion before playing the music, as in the typical arrangement using a cable connection. When an MP3 player is docked its contents are searched and the database server 20 in the PC 12 is populated to identify that content. If the MP3 player contains a database, then information is extracted from it and links are stored in database 20; if the MP3 player does not contain a database, then the stored music files are scanned for the identifying tags they contain and information in the tags is used to populate the server 20, Once a track on a docked MP3 player has been selected, it is streamed file by file, bit by bit, to the appropriate Hi-Fi 34 via a suitable Digital to Analogue converter (DAC). The DAC can be located anywhere in the signal path but in this example is shown in the PC 12 at reference 42.

It will be clear that at no time is music copied over or stored in the PC 12. Also, if any MP3 player is undocked, then its music content is no longer available.

FIG. 4 is a functional block diagram of the control software associated with the embodiment of the media player system shown in FIG. 3. A remote interface layer 50 is arranged to interface with a number of input devices; those shown are an Infrared or Touch interface 52, such as the devices conventionally used to control a television set; a Personal Digital Assistant (PDA) 54; a PC Desktop interface 56; and an interface 58 employed with a control system for an Intelligent Building. The interface layer 50 is arranged to provide a considerable proportion of the power required by each interface device, e.g. over about 50% but often about 75%, so that only the remaining about 25% of processing power needs to be provided by the input devices 52 to 58. This has the result that the interfaces are all highly responsive to change, and that interfaces can be added or altered quite easily to support new functionality.

The remote interface layer 50 also interfaces with media player software 60, one for each HiFi 34, with player control service software 62, with a utility service 64, and with a database 66.

In use, the input layer 50 instructs the player control software service software 62 to instruct the appropriate player software 60. The player software 60 takes data from the appropriate docked MP3 player 40 and plays it through the selected HiFi 34. The utility service software 64 moves files around (if required), checks which docking station has a docked MP3 player, and checks the status of all running software, then reports back to the interface layer software 50.

In use, when a track is selected by any input device for play on a selected Hi-Fi, the control software of FIG. 4 directs the correct track to the correct output.

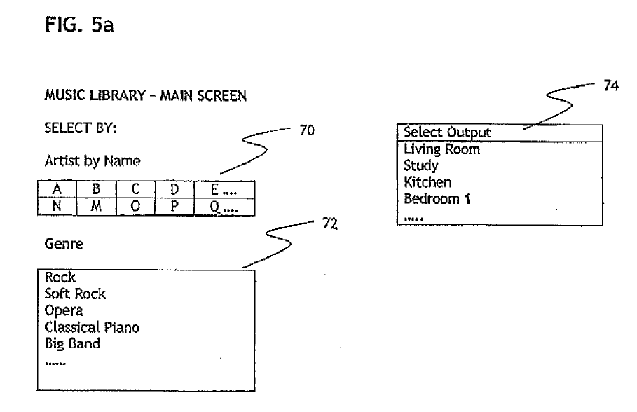

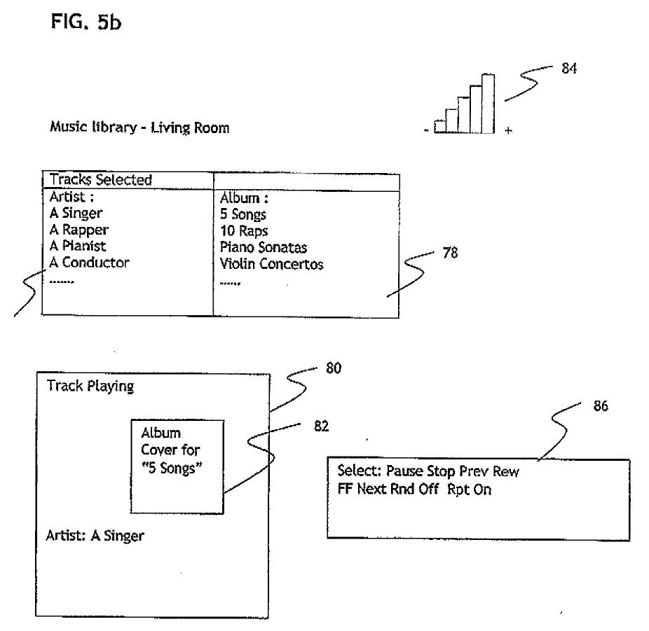

FIGS. 5A and 5B illustrate typical displays on the monitor of the media player system according to one embodiment. In FIG. 5A, the main screen display allows an artist to be selected alphabetically by name at 70 after a text search, or a genre to be selected at 72, when all tracks in that genre will be displayed. The database 66 is temporarily populated with all artists and tracks resident on all docked MP3 players to provide such displays. The desired output device is selected by name of room at 74, e.g., Living Room, Kitchen etc. FIG. 5b shows the screen associated with each room. It shows the tracks selected for play in that room by name of artist, e.g., “A Singer”, at 76 and by the name of the album at 78. The track currently playing is shown at 80, naming the artist and showing the album cover at 82. There is a volume control at 84 and a wide selection of function buttons at 86.

When a track is selected, a playlist is created which holds data, including tags, relevant to the tracks to be played, and this table is stored in database 66 in a transitory manner, If the same track is stored on two docked players, the track io will appear in duplicate. If an MP3 player is undocked, all tracks resident on it will disappear from the displays.

Although the FIGS. 3 and 6-7 show docking stations 38 for four MP3 players 40, by use of simple connection hubs to provide the required physical connections, more docks can be provided, e.g., up to 100. Although the FIGS. 3 and 6-7 show four Hi-Fis 34, more can be supported by use of satellites. As stated above, each supported Hi-Fi requires associated media player software 60.

While the invention has been described with reference to a plurality of simultaneously-docked MP3 players, in an important variation it is possible to have only a single docked MP3 player and to play simultaneously two or more tracks from it on two or more HiFis. A different track may play on each HiFi.

It is an advantage of a media play system according to an embodiment of the invention, when used to play music, that true audiophile CD quality can be provided. The MP3 players may be the well-known iPod™ of Apple, players made by iRiver or Dell or any other player in MP3 (short for the MPEG audio codec.) or WMA (Windows Media Audio) or Wave file or similar format.

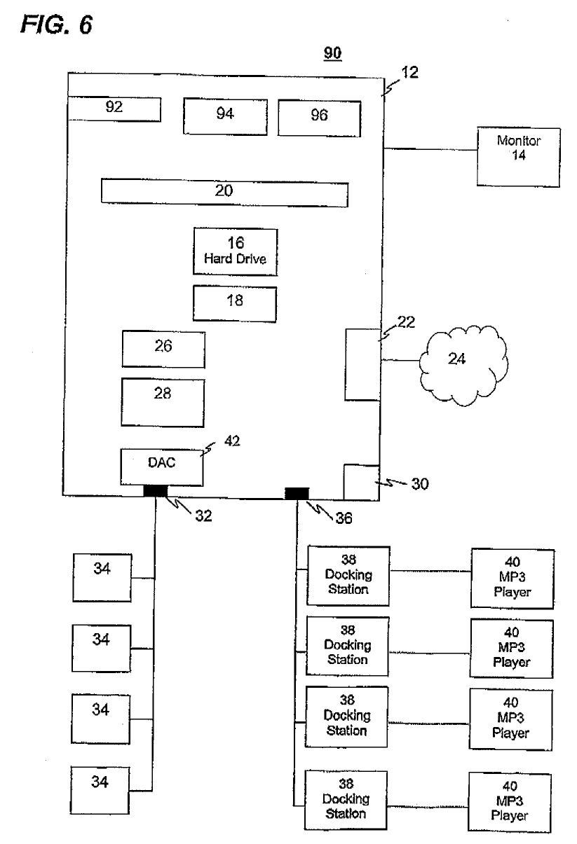

FIG. 6 is a functional block diagram of a media player system according to another embodiment of the invention. In addition to all the features of FIG. 3, the system includes a drive 92 to receive CDs, a ripping device 94 and an encoder 96 which together allow a CD to be ripped and encoded for storage in a MP3 player docked in a dock 38, there being small modifications made to the software of FIG. 4 to provide this additional functionality. This allows the media player 90 to perform the functions of ripping and encoding normally done in a PC, for storage of music in a docked player 40.

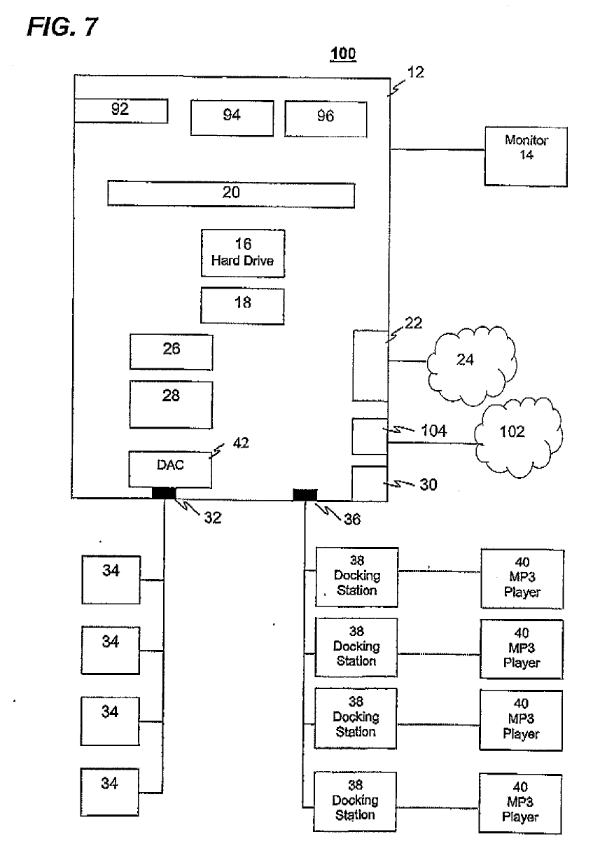

FIG. 7 is a functional block diagram of a media player system according to another embodiment of the invention. In addition to all of the hardware items of FIG. 6, the system 100 is additionally connected to a local network 102 to which music-storing hardware devices (such as PCs, laptops, NASs and the like, not shown) may be attached. The local network 102 is connected to the media server 12 via a physically wired input/output port 104 or wireless port 30.

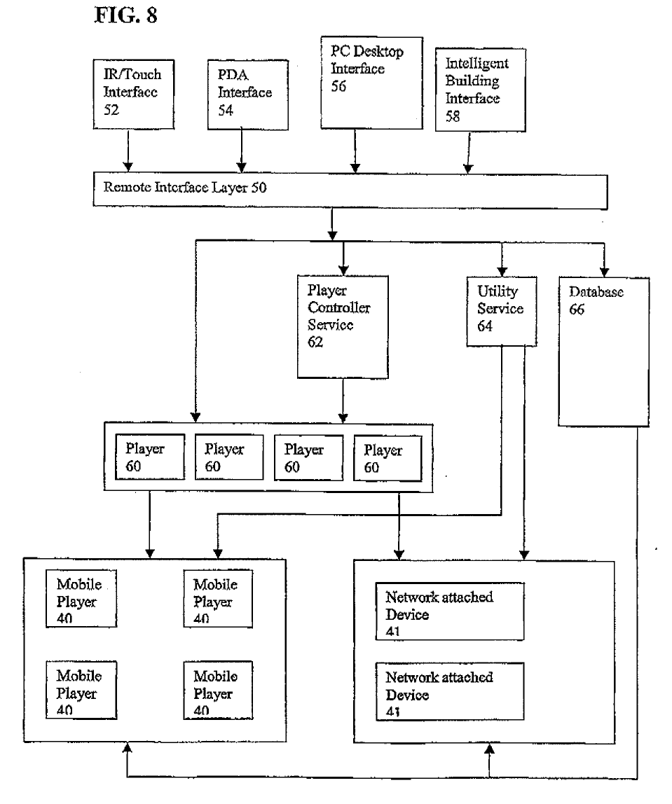

The software resident on the system 100 has a small modification to the software of FIG. 4 and is shown in FIG. 8 which differs from FIG. 4 in that two Network Attached Devices 41 are illustrated, and have connections to the players 60, the utility service 64 and the database 66. The software is arranged to provide the function of searching the local network for music files stored on networked devices. Such networked devices are discovered and catalogued automatically by the system 100 without the need for user intervention or additional software to be pre-loaded onto such devices. The system 100 then catalogues and presents the music to the user for playback in a similar way as has been described for MP3 players. When attached devices are removed from the system, the process is automatically reversed.

The media player according to at least one embodiment of the invention has an advantage that many of the items of hardware and software are standard, e.g., the hard drive and other components of the modified PC forming the basis of the player. Further, standard software such as Microsoft™ Windows and Microsoft SQL software can be used for the conventional components.

A further advantage of a media player according to another embodiment of the invention is that any music that is stored digitally on any device that can be addressed by the system, whether on a docked MP3 player or a networked device or the media player system itself, may be catalogued as one library for the purpose of easy access, control and distribution into different playback stations As an alternative to playing music originating mainly from CDs, videos originating from DVDs (Digital Versatile Discs) can be played.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A media play system comprising:
a media server comprising a plurality of outputs, wherein each of the plurality of outputs is connected to a playback station, wherein the media server is connected to at least one device that is configured to store digital content, and wherein the at least one device comprises either a mobile media player docked in a mobile media docking mechanism or a local network connected to a media track storage.

2. The media play system of claim 1, wherein a plurality of tracks from the device are output substantially simultaneously to a plurality of playback stations.

3. The media play system of claim 1, wherein the at least one device comprises a plurality of devices which are connected simultaneously to the server and wherein the media tracks stored therein are seen as a single collection of tracks.

4. The media play system of claim 1, wherein each playback station comprises an audio system.

5. The media play system of claim 1, wherein the device comprises a docked mobile media player and wherein the media tracks stored in the device are accessed digitally.

6. The media play system of claim 5, wherein any track on the docked mobile media player is streamed digitally to any playback station.

7. The media play system of claim 1, further comprising control software configured to provide a remote interface which communicates with a) an interface of at least one instruction input system; b) the plurality of outputs; and c) at least one device.

8. The media play system of claim 7, wherein the control software is further configured to provide more than half of the processing power required by each instruction input system.

9. The media play system of claim 7, wherein the device comprises a media track storage connected to a local network and the software is further configured to search the local network for music files stored the media track storage.

10. A method of outputting media, the method comprising:
retrieving a plurality of media tracks stored in a plurality of devices, wherein each of the plurality of devices comprises either a mobile media player docked in a mobile media docking mechanism or a local network connected to a media track storage and wherein the media tracks stored therein are seen as a single collection of tracks; and
substantially simultaneously outputting the plurality of media tracks to a plurality of playback stations.

11. The method of claim 10, wherein a different media track is output to each playback station.

12. The method of claim 10, wherein the plurality of media tracks can be output to any playback station in any order.

13. The method of claim 10, wherein each of the devices comprises a docked mobile media player and wherein the method further comprises digitally accessing the media tracks stored in each of the devices.

14. The method of claim 13, wherein any track on the docked mobile media player is streamed digitally to any playback station.

15. The method of claim 10, wherein each playback station comprises an audio system.

16. The method of claim 10, further comprising providing a remote interface, via control software, which communicates with a) an interface of at least one instruction input system; b) the plurality of outputs; and c) at least one device.

17. The method of claim 10, further comprising searching the local network for music files stored in the media track storage.

18. A media play system comprising:
means for retrieving a plurality of media tracks stored in a plurality of devices, wherein each of the plurality of devices comprises either a mobile media player docked in a mobile media docking mechanism or a local network connected to a media track storage and wherein the media tracks stored therein are seen as a single collection of tracks; and
means for substantially simultaneously outputting the plurality of media tracks to a plurality of playback stations.

19. The media play system of claim 18, wherein a different media track is output to each playback station.

20. The media play system of claim 18, wherein the plurality of media tracks can be output to any playback station in any order.
